(19) United States
(12) Patent Application Publication
(10) Pub. No.: US 2025/0190888 A1
(43) Pub. Date: Jun. 12, 2025

(54) CONTAINER RESOURCE MANAGEMENT METHOD AND CONTAINER RESOURCE MANAGEMENT DEVICE

(71) Applicant: TOYO SEIKAN GROUP HOLDINGS, LTD., Tokyo (JP)

(72) Inventors: Hidehiko KUNIMASA, Tokyo (JP); Suguru TANABE, Tokyo (JP); Satoshi FURUKAWA, Tokyo (JP); Hiroshi OKAMURA, Tokyo (JP); Ippei MIKI, Tokyo (JP); Yuri TAKEUCHI, Tokyo (JP)

(73) Assignee: TOYO SEIKAN GROUP HOLDINGS, LTD., Tokyo (JP)

(21) Appl. No.: 19/048,626

(22) Filed: Feb. 7, 2025

Related U.S. Application Data
(63) Continuation-in-part of application No. PCT/JP2023/023029, filed on Jun. 21, 2023.

(30) Foreign Application Priority Data
Aug. 16, 2022 (JP) 2022-129620

(51) Int. Cl. G06Q 10/0631; G06Q 10/087

(52) U.S. Cl. CPC G06Q 10/0631; G06Q 10/087

(57) ABSTRACT

Provided is a container resource management method that manages, using a computer, registration of a resource associated with a container fillable with a content, and a resource distribution for the registered resource. The method includes performing resource registration information reception that includes receiving resource registration information relating to the resource registration; performing distribution container setting that involves setting a container quantity of a container distributed in a distribution network, in accordance with the resource registration information; performing conversion of container distribution information into a value medium, the container distribution information being based on collected data collected through distribution of the container in the container quantity, the container being filled with a content and distributed in the distribution network; and performing resource distribution information generation that involves generating resource distribution information relating to distribution of a resource, by allocating the value medium on the basis of the resource registration information.

### CROSS-REFERENCE TO RELATED APPLICATIONS

This application is a continuation-in-part application of International Patent Application No. PCT/JP2023/023029, filed on 21 Jun. 2023, which application claims priority to and the benefit of JP Application No. 2022-129620, filed on 16 Aug. 2022, the disclosures of which are hereby incorporated herein by reference in their entireties.

### TECHNICAL FIELD

The disclosure relates to a container resource management method and a container resource management device.

### BACKGROUND

In the related art, as a management method used when a product, which is a container filled with a content, is distributed in a distribution network, it is known that inventory management, projecting value for exchange of the container, marketing, tracing, and the like of the product are performed using a container identification code assigned to the container. For example, JP 2003 256765 A discloses a technology for managing a product by reading a barcode printed on a container with a barcode reader. In addition, JP 2018 188199 A discloses a technology for managing a product by reading an IC tag attached to a container with a reader/writer.

In JP 2003 256765 A and JP 2018 188199 A, the management of the product is performed using a container identification code assigned to the container, and sales of the container and the product are a fundamental revenue source in a business related to the manufacturing of the container and the manufacturing of the product, which is the container filled with a content.

Therefore, in order to improve the network transactions, it is necessary to establish a new structure for processing and distributing resources in a technological environment and/or supply chain environment using a computer for implementation in addition to an exchange of resources, such as a container and products.

The disclosure has been made in view of the above problem, and an object of the disclosure is to provide a resource management method and a resource management device that realizes a new structure of registering and distributing resources in a computing system in conjunction with distribution of a container hardware.

### SUMMARY

In order to achieve the object described above, a resource management method according to an aspect of the disclosure manages, using a computer and one or more hardware sensors, to register a resource associated with an object, such as a container fillable with a content, and to distribute resources for the registered resource. The method includes performing resource registration information reception that involves receiving resource registration information relating to information corresponding, for example, to distribution of a container, performing distribution container setting that involves setting a container quantity of the container to be distributed in a distribution network, in accordance with the resource registration information, performing conversion that involves converting container distribution information into a resource value medium, the container distribution information being based on collected data collected through distribution of the container in the container quantity, the container being filled with the content and distributed in the distribution network, and resource distribution information generation that involves generating resource distribution information relating to the resource distribution, by allocating the value medium on the basis of the resource registration information.

A resource, according to the present disclosure, is an object that can represent a state and/or can be used to cause execution of one or more operations in a computing environment. A resource may be indicated by a value of a value medium and indexed by the resource identifier and stored in a database. In aspects, as a real-world example and for ease of discussion, a resource is associated with manufacturing and/or building of a container that is fillable with content for distribution in a supply chain and/or a distribution network. A value of a resource is converted from information that is collected from the container. In a container resource management method, according to an aspect of the disclosure, container distribution information is converted into a value medium associated with a resource, the container distribution information being based on collected data collected through the distribution of a container in a distribution network. A container quantity set according to resource registration information, and resource distribution information is generated by allocating the value medium on the basis of the resource registration information. Therefore, the resource registration in the container can be collected, and also the resource distribution for the resource registration can be provided. As a result, a new structure of network transaction can be realized through distribution of the container.

Resource registration as described herein refers to registration of a resource. Registering a resource in the present technology provides for the execution of subsequent operations for generating and/or collecting information in a network and converting the collected information into a value medium, thereby allocating a resource for distribution as at least a part of resource distribution. Issues, configurations, and effects other than those mentioned above will be clarified in the embodiments of the disclosure described below.

### BRIEF DESCRIPTION OF DRAWINGS

FIG. 1 is an overall view illustrating an example of a container distribution system 1.

FIG. 2 is a schematic diagram illustrating an example of containers 10 and a flow of various types of information in the container distribution system 1.

FIG. 3 is a block diagram illustrating an example of a container resource management device 2.

FIG. 4 is a data configuration diagram illustrating an example of a distribution management database 210.

FIG. 5 is a data configuration diagram illustrating an example of a container resource management database 211.

FIG. 6 is a functional explanatory diagram illustrating an example of the container resource management device 2.

FIG. 7 is a hardware configuration diagram illustrating an example of a computer 900 that constitutes each device.

FIG. 8 is a flowchart illustrating an example of a container resource management method performed by the container resource management device 2.

FIG. 9 is a flowchart (a continuation of FIG. 8) illustrating the example of the container resource management method performed by the container resource management device 2.

### DETAILED DESCRIPTION

Embodiments of the disclosure are described below with reference to the accompanying drawings. In the following, the scope of the disclosure is schematically described, mainly to the extent necessary to describe the relevant parts of the disclosure to achieve the objects of the disclosure, and the description is omitted where publicly known techniques are applied.

A resource may be stored in memory and transmitted over a network to initiate and/or terminate one or more operations. The network may be a part of cloud computing and/or a distributed network. A resource may be transmitted over a wireless or wired network in communication between a mobile computing device, a server, and other types of devices. A resource, according to the present disclosure, represents information that indicates a state of an associated object and can be used to execute operations in a computing device and a computing system. A resource may be indicated by a value of a value medium and indexed by a resource identifier. A resource may be stored in a database. In aspects, as a real-world example and for ease of discussion, a resource is associated with manufacturing and/or building of a container that is fillable with content for distribution in a supply chain. A value of a resource is converted from information that is collected from the container. In a container resource management method, according to an aspect of the disclosure, container distribution information is converted into a value medium associated with a resource, the container distribution information being based on collected data collected through the distribution of a container in a distribution network. A container quantity set according to resource registration information, and resource distribution information is generated by allocating the value medium on the basis of the resource registration information. Therefore, the resource registration in the container can be collected, and also the resource distribution for the resource registration can be provided. As a result, a new structure of network transaction can be realized through distribution of the container.

### Configuration of Container Distribution System 1

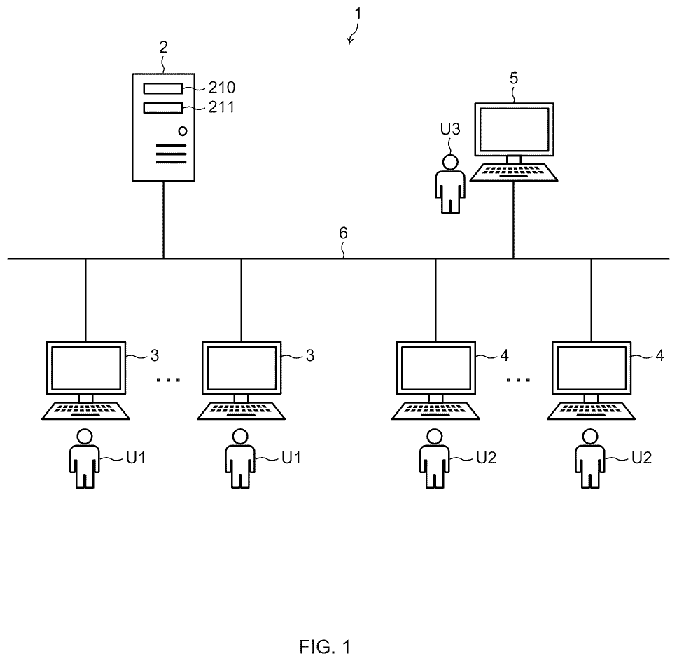

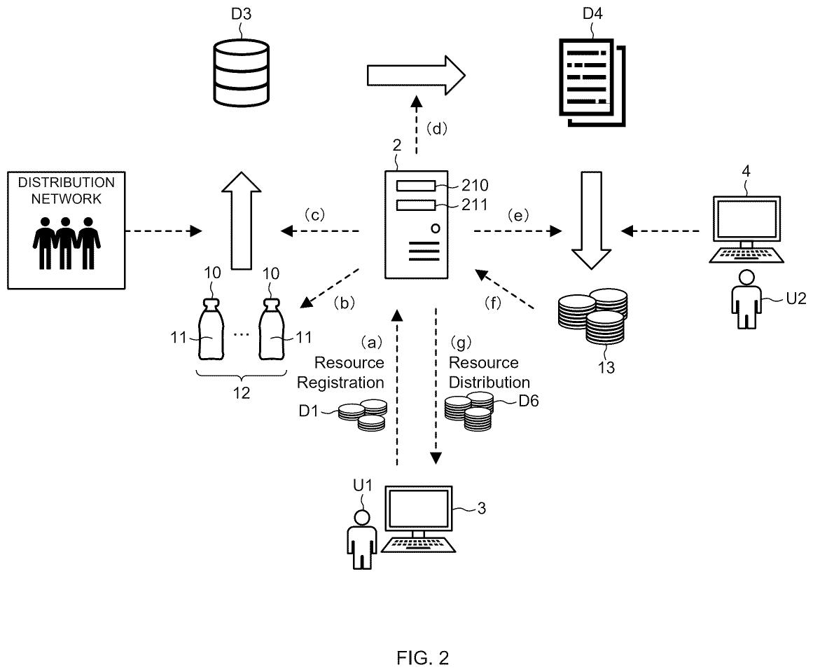

FIG. 1 is an overall view illustrating an example of a container distribution system 1 according to the present embodiment. FIG. 2 is a schematic diagram illustrating an example of containers 10 and a flow of various types of information in the container distribution system 1. The container distribution system 1 functions as a system that receives a resource registration corresponding to the containers 10 that are fillable with a content 11. The system further provides a resource allocated as resource distribution as a result of the resource registration. The allocation of the resource comprises converting, into a value medium 13 representing a value of the resource, container distribution information D4. The container distribution information D4 is based on a collected data D3 collected in the process of distributing the containers 10 that are target containers of the registered resource in a distribution network.

Continuing with the container example, each of the containers 10 is manufactured using a raw material such as plastic, metal, glass, or paper, for example, and has any shape or size. Examples of the types of the container 10 include a plastic bottle made of polyethylene terephthalate (PET) and the like, a metal can made of steel, aluminum, and the like, a glass bottle, a paper pack, and a laminated pouch. Note that the container 10 may be a returnable container or may be a single-use container. The content 11 may be liquid, solid, powder, granules, or the like. Examples of the types of the content 11 include beverages such as water, juice, milk, and the like, food, pharmaceuticals, and cosmetics. The content 11 may be at room temperature, chilled (refrigerated), or frozen. In addition, the content 11 may be heated or unheated in the manufacturing process, and may be a fresh product or a processed product in the case of beverages or food.

The containers 10, for example, represent objects that can be tracked in a digital or real-world environment. The containers may be manufactured and/or created by a container manufacturer, and the content 11 is manufactured by a content manufacturer and made to fill the containers 10 corresponding to the type of the content 11, thereby being manufactured as a product 12 distributed in the distribution network. The content manufacturer may comprise a beverage manufacturer, a food manufacturer, or the like. By specifying type and quantity of the containers 10, the containers 10 are manufactured by the container manufacturer, the containers 10 corresponding to the order are delivered from the container manufacturer and, for exchange, a resource value for the containers 10 is registered and transmitted to the container manufacturer.

The product 12, when manufactured, comprises a label. The label is printed as an identification code image (container identification code), such as a one-dimensional code or a two-dimensional code, is attached to each of the containers 10, or an electronic tag (IC tag) called an RFID is embedded in the container 10, and thus a container ID (container identification code) for identifying the container 10 on an individual basis or a lot basis is assigned to the container 10. The product 12 may be provided to a consumer (a general consumer, a business operator, or the like) in exchange for resources via, for example, a wholesaler, a retailer, or a trading company in the distribution network.

Examples of forms of the resource registration for the containers 10 include a form in which, when the content manufacturer requests the containers 10 and the type of the ordered containers 10 matches the type of the containers 10 that are target containers of the registered resource, a part or all of the resources in exchange for the containers 10 for which the resource is registered. Examples of forms of the resource registration for the containers 10 may further include a form in which when the container manufacturer manufactures the containers 10 and the type of the manufactured containers 10 matches the type of the containers 10 that are target containers of registered resource, a part or all of the manufacturing cost of the containers 10 is invested. The containers 10 that are target containers are provided to the content manufacturer in accordance with the order from the content manufacturer, and the content manufacturer can receive the provision of the target containers 10 without incurring the resource registration. On the other hand, instead of receiving the registered resource, the content manufacturer may permit the collection of the collected data D3 using the containers 10 that are target containers without holding the ownership of the containers 10 that are target containers, and may cooperate with the collection of the collected data D3, as necessary. Note that the one or more registered resources that correspond to the containers 10 are not limited to the upper limit of the resource value needed for acquiring the containers 10 or the resource value needed for manufacturing the containers 10. A value of the registered resource may exceed these values.

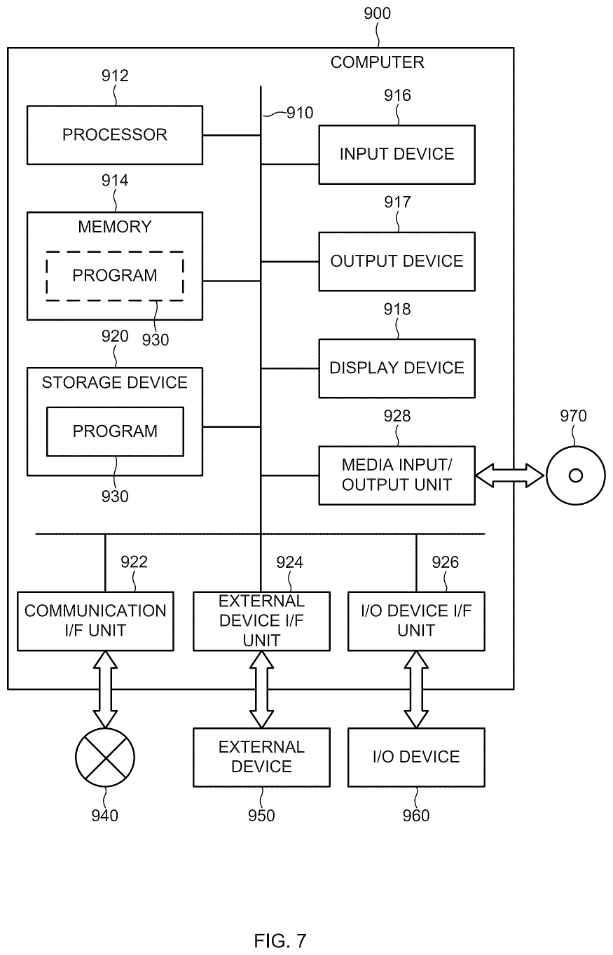

The container distribution system 1 includes, as a main component thereof, a container resource management device 2 that manages the collected data D3 collected in the process of distributing the containers 10 in the distribution network, and manages the resource registration and the resource distribution for the containers 10. The resource management device 2 is connected to a resource provider terminal device 3 used by a resource provider U1, an information user terminal device 4 used by an information user U2, and a management business operator terminal device 5 used by a management business operator U3 of the resource management device 2, via a network 6 that is a wired or wireless network. For example, the devices 2 to 5 are each constituted by a general-purpose or dedicated computer (see FIG. 7 described later), and are configured so as to be able to mutually transmit and receive various types of data via the network 6. Note that the number of each of the devices 2 to 5 and the configuration of the network 6 are not limited to the example illustrated in FIG. 1.

The container resource management device 2 is constituted by a server-type computer or a cloud-type computer, for example. The container resource management device 2 includes a distribution management database 210 capable of registering container state data acquired in each phase of manufacturing, shipping, transportation, exchange of resources (e.g., sales), consumption, and the like of the product 12 (the containers 10 filled with the content 11), and a container resource management database 211 that can register resource registration information D1 of the registered resource corresponding to the resource distribution information D6 of the resource distribution. Note that in the distribution management database 210, only the container state data related to the containers 10 that are target containers may be registered, or the container state data related to the containers 10 that are not target containers may also be registered.

When the container resource management device 2 receives the resource registration information D1 from the resource provider U1 via the resource provider terminal device 3 (arrow (a) in FIG. 2), the container resource management device 2 registers the resource registration information D1 in the container resource management database 211 and performs the resource registration for the containers 10 on the basis of the resource registration information D1 (arrow (b) in FIG. 2). Then, when the product 12, which corresponds to the containers 10 that are target containers filled with the content 11, is distributed in the distribution network, the container ID assigned to the container 10 is read by a reader device (not illustrated) such as a code reader, a camera, or an electronic-tag reader, and thus the container resource management device 2 registers, in the distribution management database 210, the container state data indicating the state of each phase of the product 12 in association with the container ID and collects the collected data D3 as a dataset of the container state data (arrow (c) in FIG. 2).

The reader device is used in respective phases of distribution in the distribution network, and is installed in respective locations, such as a manufacturing factory, a logistics base, a transportation vehicle, a sales store, a refrigerator in a home of a consumer, and the like. At this time, the reader device may be a fixed type or a handheld type, may be an integrated type integrated into a portable computer (such as a smartphone), or the like. Examples of the container state data include a manufacturing date and time, a manufacturing location, a shipment date and time, a transportation time, a transportation temperature, a resource exchange date and time, a resource for exchange value, a resource exchange location, a consumption date and time, a consumer ID, a consumption location, a storage temperature, and the like. A part of the container state data may be acquired by a state detection device (such as a temperature sensor) installed at each location, similarly to the reading device. The container resource management device 2 may acquire the container state data in cooperation with a reading device, a state detection device, and a database included in an external system (such as a manufacturing management system, a transportation management system, or a sales management system) or in cooperation with an external application (such as a net shopping application or a refrigerator management application). In this case, personal information (such as sex, age, and preference) related to the consumer associated with the consumer ID may be collected as a part of the container state data.

In addition, the container resource management device 2 generates the container distribution information D4 based on the collected data D3 collected by distributing the containers 10 that are target containers (i.e., the product 12) in the distribution network (arrow (d) in FIG. 2). The container resource management device 2 may further convert the container distribution information D4 into the value medium 13 by providing the container distribution information D4 to the information user U2 via the information user terminal device 4 (arrow (e) in FIG. 2). Then, the container resource management device 2 generates the resource distribution information D6 by allocating the value medium 13 on the basis of the resource registration information D1 (arrow (f) in FIG. 2), registers the resource distribution information D6 in the container resource management database 211, and provides the distributed resource to the resource provider U1 based on the resource distribution information D6 (arrow (g) in FIG. 2).

The resource provider terminal device 3 is constituted by, for example, a stationary computer or a portable computer, and is used by the resource provider U1. The resource provider terminal device 3 is installed with a program such as an application or a browser, receives various types of input operations, and outputs various types of information via a display screen or a voice. The resource provider terminal device 3 supports the resource provider U1 by, for example, receiving an input operation for instructing a new resource registration or instructing a status check of the resource registration or the resource distribution, and displaying the resource registration information D1 or the resource distribution information D6 on the display screen.

The information user terminal device 4 is constituted by, for example, a stationary computer or a portable computer, and is used by the information user U2. Similarly to the resource provider terminal device 3, the information user terminal device 4 is installed with a program such as an application or a browser, receives various types of input operations, and outputs various types of information via a display screen or a voice. The information user terminal device 4 supports the information user U2 by, for example, receiving an input operation for instructing the provision of the container distribution information D4 or instructing a conversion condition for converting the container distribution information D4 into the value medium 13, and displaying the container distribution information D4 and the conversion condition on the display screen.

The management business operator terminal device 5 is constituted by, for example, a stationary computer or a portable computer, and is used by the management business operator U3. Similarly to the resource provider terminal device 3, the management business operator terminal device 5 is installed with a program such as an application or a browser, receives various types of input operations, and outputs various types of information via a display screen or a voice. The management business operator terminal device 5 supports the management business operator U3 by, for example, receiving an input operation for instructing a status check of the resource registration or the resource distribution, and displaying the resource distribution management database 210 and the container resource management database 211 on the display screen.

### Configuration of Container Resource Management Device 2

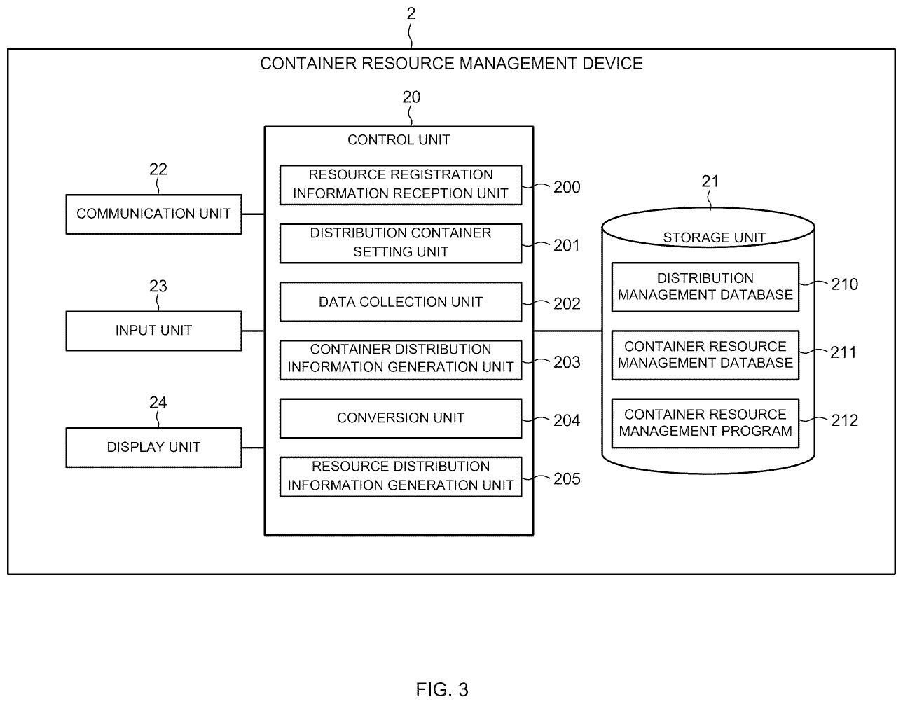

FIG. 3 is a block diagram illustrating an example of the container resource management device 2 according to the present embodiment. The container resource management device 2 comprises a control unit 20 constituted by a processor and the like, a storage unit 21 constituted by an HDD, an SSD, a memory, and the like, a communication unit 22 that is a communication interface with the network 6, an input unit 23 constituted by a keyboard, a mouse, and the like, and a display unit 24 constituted by a display and the like. Note that the input unit 23 and the display unit 24 may be omitted.

The storage unit 21 stores the distribution management database 210, the container resource management database 211, and a container resource management program 212, and also stores an operating system, other programs, various types of data, and the like.

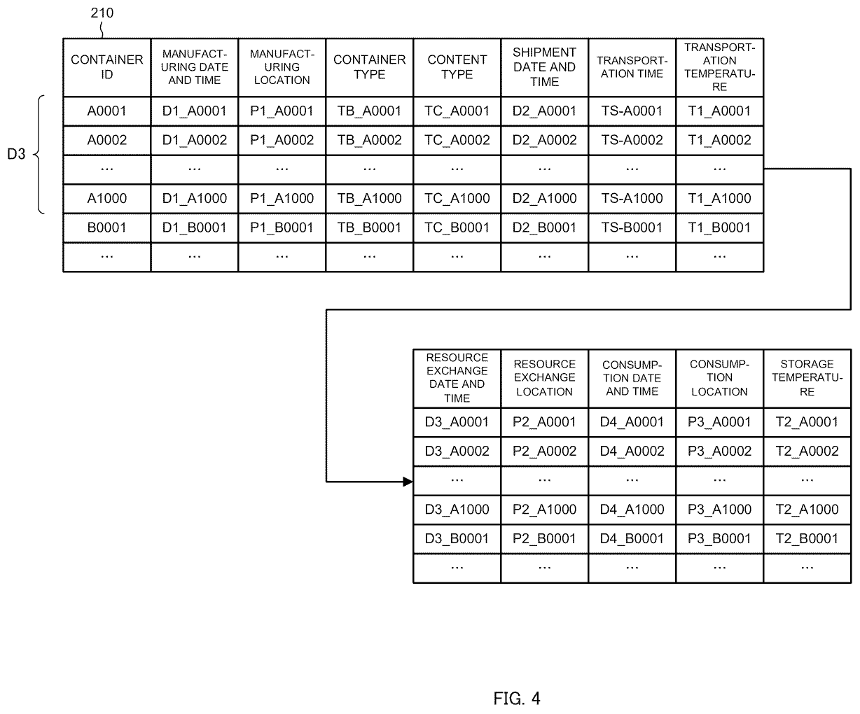

FIG. 4 is a data configuration diagram illustrating an example of the distribution management database 210. The distribution management database 210 has a record for each of the container IDs. Each record has fields in which, for example, the manufacturing date and time, the manufacturing location, a container type, a content type, the shipment date and time, the transportation time, the transportation temperature, the resource exchange date and time, the resource exchange location, the consumption date and time, the consumption location, the storage temperature, and the like can be registered as the container state data.

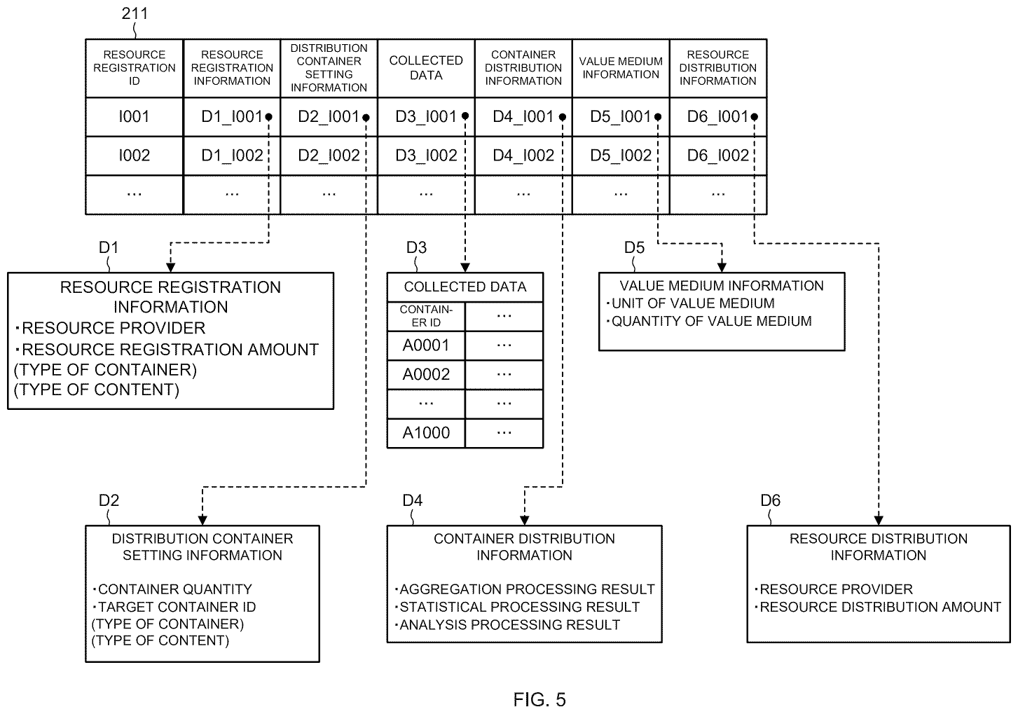

FIG. 5 is a data configuration diagram illustrating an example of the container resource management database 211. The container resource management database 211 has a record for each of the resource registration IDs for associating various types of information handled in the container resource management method with each other. Each record has fields in which, for example, the resource registration information D1, distribution container setting information D2, the collected data D3, the container distribution information D4, value medium information D5, the resource distribution information D6, and the like can be registered. Note that the container resource management database 211 can be referred to from the management business operator terminal device 5, and editing operations such as addition, deletion, and modification of each data may be performed by the management business operator U3 on the display screen of the management business operator terminal device 5.

The resource registration information D1 includes at least the resource provider U1 and an amount of a resource registered by the resource provider U1. When there are a plurality of resource providers U1, the resource registration information D1 comprises the amount used by a respective resource provider of the plurality of resource providers U1. Note that the resource registration information D1 may include at least one of the type of the containers 10 that are target containers or the type of the content 11 that is to fill the containers 10 that are target containers.

The distribution container setting information D2 includes at least the container quantity of the containers 10 that are target containers and an target container ID specifying the container 10 that is an target container, using the container ID. Note that the distribution container setting information D2 may include at least one of the type of the containers 10 that are target containers or the type of the content 11 that is to fill the containers 10 that are target containers.

The collected data D3 is constituted by the dataset of the container state data acquired by distributing the containers 10 that are target containers (in actuality, the product 12) in the distribution network. For example, in the record specified by the resource registration ID “1001”, when the distribution container setting information D2 is set with the container quantity “1000” and the target container IDs “A0001 to A1000”, the collected data D3 is constituted by the container state data for 1000 of the containers 10, as illustrated in FIG. 4.

The container distribution information D4 is, for example, generated by performing data analysis processing such as aggregation processing, statistical processing, and analytical processing on the collected data D3, and includes an aggregation processing result, a statistical processing result, an analytical processing result, and the like. Note that, instead of or in addition to the result of the data analysis processing, the container distribution information D4 may include the collected data D3 itself, or may be obtained by deleting a portion of the data related to personal information of the consumer from the collected data D3.

The value medium information D5 includes at least the unit of the value medium 13 and the quantity of the value medium 13. The value medium 13 is a resource value transferred by the information user U2 in exchange for the provision of the container distribution information D4, and for example, when the payment is made in any chosen currency, the quantity of the value medium 13 corresponds to the payment amount. Note that the currency may be a digital currency.

The resource distribution information D6 includes at least the resource provider U1 and the resource distribution amount for the resource provider U1. When there are a plurality of the resource providers U1, the resource distribution amount for one or more of the resource providers U1 is included.

Note that the data configuration of the distribution management database 210 (FIG. 4) and the container resource management database 211 (FIG. 5) are not limited to the examples described above and may be changed as appropriate. A part of the data described above may be omitted, or data other than the data described above may be added. In addition, a part or all of the distribution management database 210 and the container resource management database 211 may be stored in an external device (or a plurality of external devices) that can be connected to the network 6. In this case, the control unit 20 may access the external device via the communication unit 22.

As illustrated in FIG. 3, the control unit 20 functions as a resource registration information reception unit 200, a distribution container setting unit 201, a data collection unit 202, a container distribution information generation unit 203, a conversion unit 204, and a resource distribution information generation unit 205 by executing the container resource management program 212 stored in the storage unit 21.

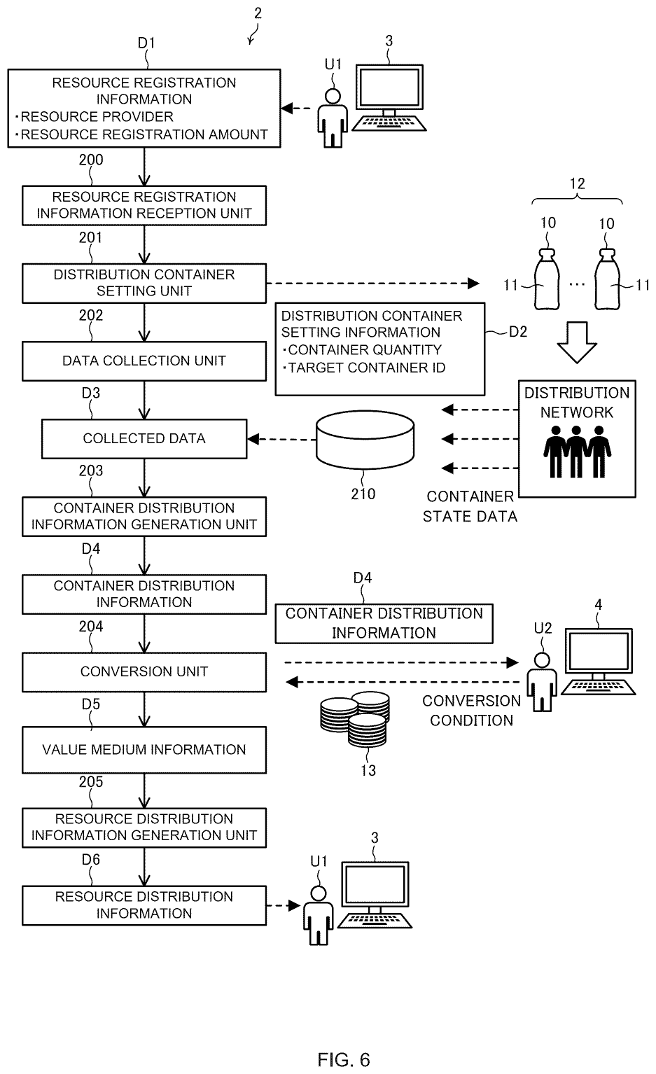

FIG. 6 is a functional explanatory diagram illustrating an example of the container resource management device 2 according to the present embodiment.

The resource registration information reception unit 200 receives the resource registration information D1 from the resource provider terminal device 3. For example, the resource registration information reception unit 200 causes the resource provider terminal device 3 to display a display screen on which the resource registration information D1 can be input, receives, as the resource registration information D1, the resource registration amount, the type of the containers 10 that are target containers, the type of the content 11 that is to fill the containers 10 that are target containers, and the like input on the display screen, and registers the information D1 in the container resource management database 211.

The distribution container setting unit 201 sets the container quantity of the containers 10 to be distributed in the distribution network in accordance with the resource registration information D1 received by the information reception unit 200. For example, the distribution container setting unit 201 sets the container quantity of the containers 10 that are target containers, by dividing the resource registration amount in the resource registration information D1 by the manufacturing unit resource value of the containers 10. At this time, when there are a plurality of the resource providers U1 included in the resource registration information D1, the distribution container setting unit 201 totals the resource registration amount for each of the resource providers U1 and divides the total amount by the manufacturing unit resource value of the containers 10 to set the container quantity of the containers 10 that are target containers. Then, the distribution container setting unit 201 specifies, as the target container ID, the container ID assigned to the target container 10.

At this time, the distribution container setting unit 201 may select the type of the resource registration target container 10 in accordance with the resource registration information D1. For example, when the type of the container 10 is included in the resource registration information D1, the distribution container setting unit 201 may select the type of the container 10 in accordance with the resource registration information D1. Otherwise, the distribution container setting unit 201 may select the type of the container 10 in accordance with the resource registration amount in the resource registration information D1. For example, when the resource registration amount is high, the distribution container setting unit 201 may select the container 10 having a high manufacturing unit resource value. Note that the distribution container setting unit 201 may select a plurality of the types of the container 10.

In addition, the distribution container setting unit 201 may select the type of the content 11 that is to fill the target container 10 in accordance with the resource registration information D1. For example, when the type of the content 11 is included in the resource registration information D1, the distribution container setting unit 201 may select the type of the content 11 in accordance with the resource registration information D1. Otherwise, the distribution container setting unit 201 may select the type of the content 11 in accordance with the resource registration amount in the resource registration information D1. For example, when the resource registration amount is high, the distribution container setting unit 201 may select the content 11 having a high manufacturing unit resource value. Note that the distribution container setting unit 201 may select a plurality of types of the content 11.

Then, the distribution container setting unit 201 registers, in the container resource management database 211, a result of setting the container quantity, the target container ID, and the like of the target container 10, as the distribution container setting information D2.

The data collection unit 202 collects, as the collected data, the container state data indicating a state obtained when the containers 10 of the container quantity set by the distribution container setting unit 201, that is, the containers 10 that are target containers, are distributed in the distribution network. For example, the data collection unit 202 refers to the distribution management database 210 using the target container ID in the distribution container setting information D2 as a key, and extracts a record having the container ID that matches the target container ID. Then, the data collection unit 202 acquires the container state data registered in the field of the extracted record, and registers the acquired result in the container resource registration management database 211 as the collected data D3.

The container distribution information generation unit 203 generates the container distribution information D4 by performing data analysis processing such as aggregation processing, statistical processing, and analytical processing on the collected data D3 collected by the data collection unit 202. For example, the container distribution information generation unit 203 calculates an average period from the purchase date and time to the consumption date and time, an average value of the storage temperature, and the like, and registers the calculated result in the container resource management database 211 as the container distribution information D4. Note that for the data analysis processing, for example, any aggregation method, statistical method, analytical method, and the like can be adopted.

The conversion unit 204 converts the container distribution information D4 generated by the container distribution information generation unit 203, that is, the container distribution information D4 based on the collected data D3, into the value medium 13, and registers the result of the conversion as the value medium information D5 in the container resource management database 211. For example, the conversion unit 204 converts the container distribution information D4 into the value medium 13 by causing the information user terminal device 4 to display the display screen on which the conversion condition for converting the container distribution information D4 into the value medium 13 can be input and by receiving the conversion condition input on the display screen. The conversion condition includes, for example, an amount of payment made by the information user U2 for the provision of the container distribution information D4.

Note that the conversion unit 204 may adopt a value-for-exchange method. In this case, the conversion unit 204 is configured to be able to receive the conversion condition from a plurality of information user terminal devices 4 with respect to a specific piece of the container distribution information D4, and when a plurality of conversion conditions are received from the plurality of information user terminal devices 4, converts the container distribution information D4 into the value medium 13 on the basis of the conversion condition that maximizes the value medium 13. As a result, the value medium 13 is maximized, and the resource distribution can be increased further.

The resource distribution information generation unit 205 generates the resource distribution information D6 by allocating, on the basis of the resource registration information D1, the post-conversion value medium 13 converted by the conversion unit 204, that is, the value medium 13 in the value medium information D5. For example, when the resource distribution information D6 includes the plurality of resource providers U1, the resource distribution information generation unit 205 calculates the resource distribution amount for each of the resource providers U1 by proportionally dividing the value medium 13 based on the resource registration amount of each of the resource providers U1, and registers the resource distribution amount in the container resource management database 211 as the resource distribution information D6. Then, the resource distribution information generation unit 205 provides the resource distribution to the resource provider U1 on the basis of the resource distribution information D6, and transmits resource distribution notification information indicating the result of distributing the resource to the resource provider terminal device 3.

Note that the resource distribution information generation unit 205 may allocate the value medium 13 that has been subjected to cost deduction, which is obtained by deducting the cost-equivalent value medium 13, which is equivalent to at least a part of the cost required for the distribution of the containers, from the post-conversion value medium 13 converted by the conversion unit 204. For example, by allocating a part of the cost-equivalent value medium 13 to the container manufacturer or the content manufacturer, the resource value competitiveness of the container 10 and the product 12 can be improved, thereby facilitating the collection of the collected data D3. In addition, by allocating a part of the cost-equivalent value medium 13 to the management business operator U3, management work such as the operation and maintenance of the container resource management device 2 can be appropriately performed.

FIG. 7 is a hardware configuration diagram illustrating an example of a computer 900 that constitutes each device.

Each of the devices 2 to 5 of the container distribution system 1 is constituted by the computer 900 that is a general-purpose or dedicated computer. As illustrated in FIG. 7, the computer 900 includes, as main components thereof, a bus 910, a processor 912, a memory 914, an input device 916, an output device 917, a display device 918, a storage device 920, a communication I/F (interface) unit 922, an external device I/F unit 924, an I/O (input/output) device I/F unit 926, and a media input/output unit 928. Note that the above-mentioned components may be omitted as necessary in accordance with the application of the computer 900.

The processor 912 is composed of one or a plurality of computation processing devices (such as CPU (Central Processing Unit), MPU (Micro-processing unit), DSP (digital signal processor), and GPU (Graphics Processing Unit)) to operate as a control section that generally controls the entirety of the computer 900. The memory 914 is composed of a volatile memory (such as DRAM and SRAM) that stores various data and a program 930 and functions as a main memory, a nonvolatile memory (ROM), a flash memory, and the like, for example.

The input device 916 is constituted by, for example, a keyboard, a mouse, numeric keys, an electric pen, or the like, and functions as an input unit. The output device 917 is constituted by, for example, a sound (voice) output device, a vibration device, or the like, and functions as an output unit. The display device 918 is constituted by, for example, a liquid crystal display, an organic EL display, electronic paper, a projector, or the like, and functions as an output unit. The input device 916 and the display device 918 may be integrally formed as a touch panel display. The storage device 920 is constituted by, for example, an HDD, an SSD, or the like, and functions as a storage unit. The storage device 920 stores various data required for executing operating systems and the program 930.

The communication I/F unit 922 is connected to a network 940 (which may be the same as the network 6 in FIG. 1), such as the Internet and an intranet, in a wired or wireless manner, and functions as a communication unit that transmits and receives data to and from other computers in accordance with a predetermined communication standard. The external device I/F unit 924 is connected to an external device 950, such as a camera, a printer, a scanner, or a reader/writer, in a wired or wireless manner, and functions as a communication unit that transmits and receives data to and from the external device 950 in accordance with a predetermined communication standard. The I/O device I/F unit 926 is connected to an I/O device 960 such as various sensors and actuators, and functions as a communication unit that transmits to and receives from the I/O device 960 data and various signals such as a detection signal of a sensor and a control signal to an actuator, for example. The media input/output part 928 is constituted by a drive device such as a DVD (Digital Versatile Disc) drive or a CD (Compact Disc) drive, a memory card slot, or a USB connector, and reads and writes data from and to a medium (non-transitory storage medium) 970 such as a DVD, a CD, a memory card, or a USB memory.

In the computer 900 with the above-mentioned configuration, the processor 912 loads the program 930 stored in the storage device 920 into the memory 914 and executes it to control each unit of the computer 900 through the bus 910. Note that the program 930 may be stored in the memory 914 instead of the storage device 920. The program 930 may be stored in the media 970 in an installable file format or an executable file format, and provided to the computer 900 through the media input/output part 928. The program 930 may be provided to the computer 900 by downloading it via the network 940 through the communication I/F unit 922. In addition, the computer 900 may realize various functions that are realized by the processor 912 executing the program 930 using hardware such as an FPGA (field-programmable gate array) or an ASIC (application specific integrated circuit).

The computer 900 is, for example, any form of an electronic device constituted by a stationary computer or a portable computer. The computer 900 may be a client-type computer, a server-type computer, or a cloud-type computer.

### Operation of Container Distribution System 1

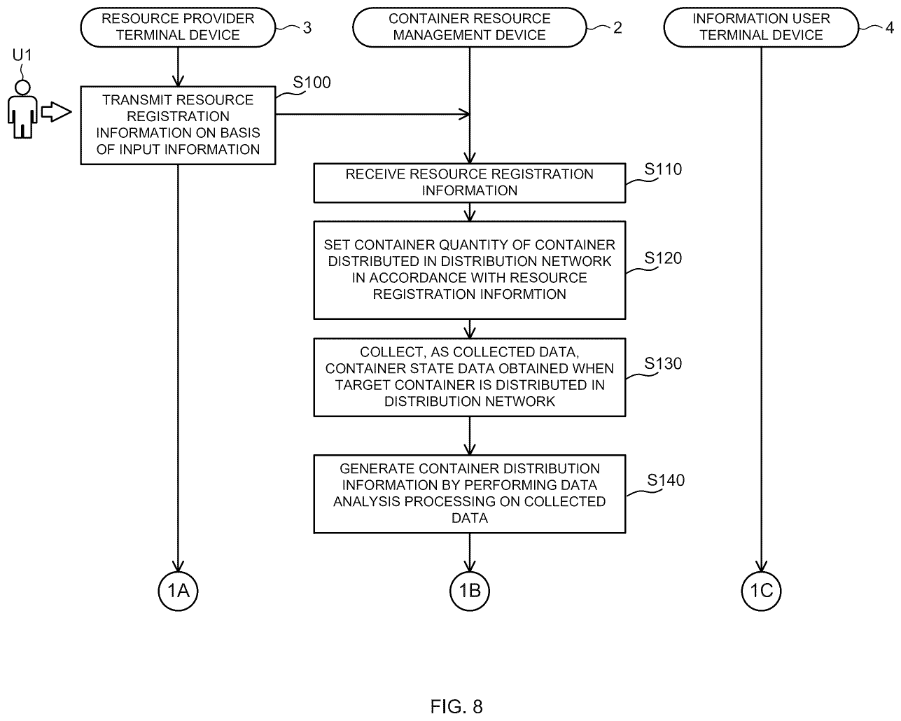

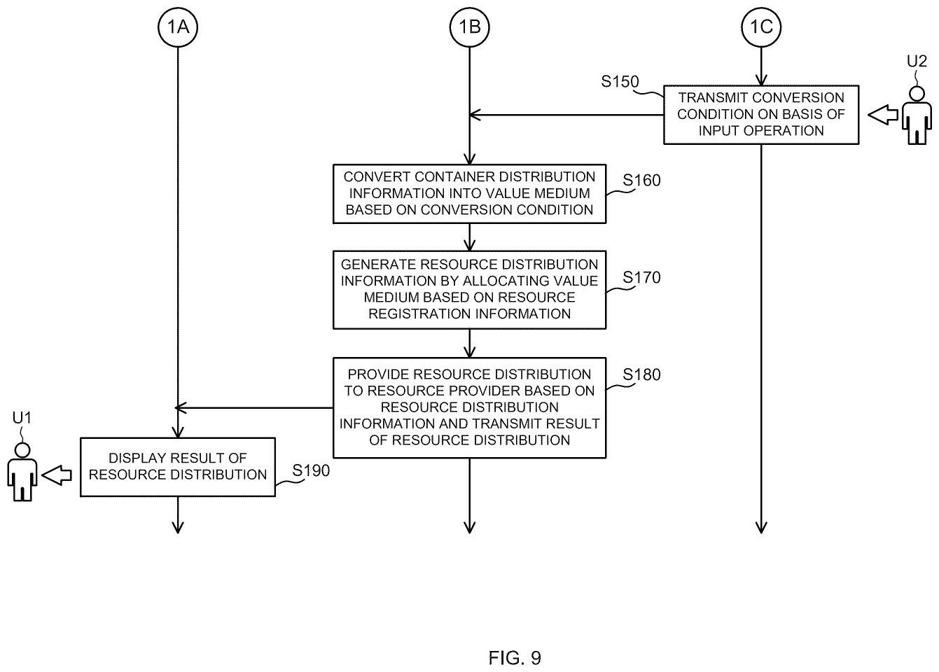

FIGS. 8 and 9 are flowcharts illustrating an example of a container resource management method performed by the container resource management device 2 according to the present embodiment. Note that the container resource management device 2 accesses the distribution management database 210 and the container resource management database 211 in order to register or refer to each of the information D1 to D6, but in the following description, the access operation will be appropriately omitted.

First, at step S100, when the resource provider U1 uses the resource provider terminal device 3 to successfully perform a login process to the container resource management device 2, the resource provider terminal device 3 displays a display screen for inputting the resource registration information D1 by communicating with the resource registration information reception unit 200, and transmits the resource registration amount and the like input on the display screen to the container resource management device 2 as the resource registration information D1. Note that it may be possible to input the type of the containers 10 that are target containers and the type of the content 11 that is to fill the containers 10 that are target containers on the display screen.

Subsequently, at step S110, the resource registration information reception unit 200 receives the resource registration information D1 transmitted at step S100. At this time, when related to a new resource registration, the resource registration information reception unit 200 allocates a new resource registration ID and registers the new resource registration ID in the container resource management database 211, and when related to an existing resource registration, the resource registration information reception unit 200 associates the resource registration with an existing resource registration ID and the associated data in the container resource management database 211.

Subsequently, at step S120, the distribution container setting unit 201 sets the container quantity of the containers 10 to be distributed in the distribution network in accordance with the resource registration information D1, and specifies, as the target container ID, the container ID assigned to the containers 10 that are target containers corresponding to the set container quantity.

Subsequently, at step S130, the data collection unit 202 refers to the distribution management database 210 using the target container ID as a key, and collects, as the collected data D3, the container state data obtained when the product 12, which has been manufactured by filling the containers 10 that are target containers with the content 11, is distributed in the distribution network.

Subsequently, at step S140, the container distribution information generation unit 203 generates the container distribution information D4 by performing data analysis processing on the collected data D3 collected at step S130.

Then, at step S150, when the information user U2 uses the information user terminal device 4 to successfully perform the login process to the container resource management device 2, the information user terminal device 4 displays a display screen for inputting the conversion condition by communicating with the conversion unit 204, and transmits, to the container resource management device 2, the payment amount and the like input on the display screen as the conversion condition.

Subsequently, at step S160, when the conversion unit 204 receives the conversion condition transmitted at step S150, the conversion unit 204 converts the container distribution information D4 into the value medium 13 on the basis of the conversion condition.

Subsequently, at step S170, the resource distribution information generation unit 205 generates the resource distribution information D6 by allocating the value medium 13 converted at step S160, on the basis of the resource registration information D1. Then, at step S180, the resource distribution information generation unit 205 provides the resource distribution to the resource provider U1 on the basis of the resource distribution information D6, and transmits the resource distribution notification information indicating the result of the resource distribution provision to the resource provider terminal device 3.

Subsequently, at step S190, when the resource provider terminal device 3 receives the resource distribution notification information transmitted at step S180, the resource provider terminal device 3 displays the result of the resource distribution on the basis of the resource distribution notification information, and the resource provider U1 can thus check the result of the resource distribution for the resource registration.

As described above, a series of processing illustrated in FIGS. 8 and 9 is completed. Note that, in the series of processing described above, steps S100 and S110 correspond to an resource registration information reception step, step S120 corresponds to a distribution container setting step, step S130 corresponds to a data collection step, step S140 corresponds to a container distribution information generation step, steps S150 and S160 correspond to a conversion step, and steps S170 and S180 correspond to a resource distribution information generation step.

As described above, according to the container resource management device 2 (an example of a computer) and the container resource management method using the container resource management device 2 according to the present embodiment, the container distribution information D4, which is based on the collected data D3 collected through distribution of the containers 10 of the container quantity set in accordance with the resource registration information D1 in the distribution network, is converted into the value medium 13, and the resource distribution information D6 is generated by allocating the value medium 13 on the basis of the resource registration information D1. Therefore, the resource registration for the containers 10 can be collected, and also the resource distribution for the resource registration can be provided. As a result, a new resource reception structure can be realized through the distribution of the container 10. A value medium is non-transitory medium and does not include a carrier wave or other propagated or modulated data signal. A communication medium, which is distinct from the value medium, may be embodied by computer readable instructions, data structures, program tools, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

### OTHER EMBODIMENTS

The disclosure is not restricted to the embodiments described above, but can be implemented with various changes within the scope of not departing from the main purpose of the disclosure. All of them are included in the technical concept of the disclosure.

In the embodiment described above, the function of each unit included in the container resource management device 2 is described as being realized by one device. However, the function of each unit may be distributed among a plurality of devices (computers) to be realized by a plurality of devices.

In the embodiment described above, the case has been described in which the container resource management device 2 functions as the respective units 200 to 205 that execute the respective steps (steps S100 to S190) included in the container resource management method, in accordance with the flowcharts illustrated in FIGS. 8 and 9. However, some of the respective steps (respective units) may be omitted. For example, in the container resource management method (container resource management device 2), at least one of the data collection step (data collection unit 202) and the container distribution information generation step (container distribution information generation unit 203) may be omitted, and each omitted step (each omitted unit) may be executed by an external system (a manufacturing management system, a transportation management system, a sales management system, a data analysis system, or the like). In this case, the container resource management method (container resource management device 2) may be executed in cooperation with the external system. 7

Aspects of the present disclosure will be collectively described in the following supplementary notes.

### Supplementary Note 1

A container resource management method manages, using a computer, a resource registration in a container fillable with a content, and a resource distribution for the resource registration. The method includes performing resource registration information reception that involves receiving resource registration information relating to the resource registration, performing distribution container setting that involves setting a container quantity of the container distributed in a distribution network, in accordance with the resource registration information, performing conversion that involves converting container distribution information into a value medium, the container distribution information being based on collected data collected through distribution of the container in the container quantity, the container being filled with the content and distributed in the distribution network, and resource distribution information generation that involves generating resource distribution information relating to the resource distribution, by allocating the value medium on the basis of the resource registration information.

### Supplementary Note 2

In the container resource management method according to Supplementary Note 1, the distribution container setting includes selecting a type of the container to be distributed in the distribution network in accordance with the resource registration information.

### Supplementary Note 3

In the container resource management method according to Supplementary Note 1 or 2, the distribution container setting includes selecting a type of the content that is to fill the container to be distributed in the distribution network in accordance with the resource registration information.

### Supplementary Note 4

In the container resource management method according to any one of Supplementary Notes 1 to 3, when a plurality of proposals for conversion conditions are received for converting the container distribution information into the value medium, the conversion includes converting the container distribution information into the value medium on the basis of the conversion condition maximizing the value medium.

### Supplementary Note 5

In the container resource management method according to any one of Supplementary Notes 1 to 4, the resource distribution information generation includes allocating a post-cost-deduction value medium, the post-cost-deduction value medium being obtained by subtracting a cost-equivalent value medium equivalent to at least a part of a cost required for the distribution of the containers, from the value medium converted by the conversion.

### Supplementary Note 6

The container resource management method according to any one of Supplementary Notes 1 to 5, further includes performing data collection that involves collecting, as the collected data, container state data indicating a state when the container of the container quantity is distributed in the distribution network, and performing container distribution information generation that involves generating the container distribution information by performing data analysis processing on the collected data.

### Supplementary Note 7

A container resource management device manages registering a resource associated with a container fillable with a content, and a resource distribution for the resource registration. The device includes a resource registration information reception unit configured to receive resource registration information relating to the resource registration, a distribution container setting unit configured to set a container quantity of the container distributed in a distribution network, in accordance with the resource registration information, a conversion unit configured to convert container distribution information to a value medium, the container distribution information being based on collected data collected through distribution of the container in the container quantity, the container being filled with the content and distributed in the distribution network, and a resource distribution information generation unit configured to generate resource distribution information relating to the resource distribution, by allocating the value medium on the basis of the resource registration information.

In some aspects, the resource as described according to the present technology corresponds to a memory of a computing device. The resource registration comprises registering a received first value of a value medium in a first memory. In exchange for the registered value as stored in the first memory, the present technology describes manufacturing operation to manufacture a container according to a quantity as specified by the registered value and filling the manufactured container with content. The present technology further comprises generating container distribution information as the container filled with the content moves in a distribution network while capturing container information using one or more reading devices. Given the generated container distribution information, the present technology further comprises determining a second value of the value medium, in exchange for the generated container distribution information. In response to receiving the second value of the value medium and stored in a second memory, the present technology further describes moving the second value of the value medium from the second memory to the first memory for storage as resource distribution. Accordingly, the resource registration triggers generating and moving the container with content. Resource distribution occurs based on exchanging the container distribution information for a value of a value medium. A pair of resource registration and resource distribution as stored in the first memory enables iterative operations of distributing the container with the content and generating the container distribution information, thereby improves memory utilization of the container resource management system. In some aspects, the container distribution network comprises a distribution path for distributing a container that is filled with content and a data communication path for transmitting container distribution information. A memory stores respective resources comprising a resource for resource registration, a resource that has been converted from the container distribution information, a resource for resource distribution, and the like.

Resource registration as referred to herein includes but not limited to registration of a resource. Resource distribution as referred to herein includes but not limited to distribution of a resource.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A computer implemented method for processing a resource in exchange for a container, comprising:
receiving resource registration information of registering a resource;
assigning a container quantity of the container to be distributed in a distribution network, in accordance with the resource registration information;
converting container distribution information to a value medium, the container distribution information being based on data collected through distribution of the container in the container quantity, the container being filled with the content, and the container being distributed in the distribution network; and
generating resource distribution information of distributing the resource, by allocating the value medium on the basis of the resource registration information.

2. The computer implemented method according to claim 1, wherein
the assigning further comprises selecting a type of the container to be distributed in the distribution network in accordance with the resource registration information.

3. The computer implemented method according to claim 1, wherein
the assigning further comprises selecting a type of the content that is to fill the container to be distributed in the distribution network in accordance with the resource registration information.

4. The computer implemented method according to claim 1, wherein
the converting further comprises converting the container distribution information into the value medium on the basis of the conversion condition maximizing the value medium, in response to receiving a plurality of conversion candidate conditions for converting the container distribution information into the value medium.

5. The computer implemented method according to claim 1, wherein
the generating the resource distribution information further comprises allocating a post-cost-deduction value medium, the post-cost-deduction value medium being obtained by subtracting a cost-equivalent value medium equivalent to at least a part of a cost required for the distribution of the containers, from the value medium converted by the conversion.

6. The computer implemented method according to claim 1, further comprising:
collecting, as the collected data, container state data indicating a state when the container of the container quantity is distributed in the distribution network; and
generating the container distribution information by performing data analysis processing on the collected data.

7. A container resource management device comprising a processor configured execute operations comprising:
receiving resource registration information of a resource registration;
assigning a container quantity of the container distributed in a distribution network, in accordance with the resource registration information;
converting container distribution information to a value medium, the container distribution information being based on collected data collected through distribution of the container in the container quantity, the container being filled with the content and distributed in the distribution network; and
generating resource distribution information of distributing a resource for distribution, by allocating the value medium on the basis of the resource registration information.
